(19) United States
(12) Patent Application Publication
(10) Pub. No.: US 2025/0387812 A1
(43) Pub. Date: Dec. 25, 2025

(54) GEOTHERMAL POWER GENERATION SYSTEM

(71) Applicant: FUJI ELECTRIC CO., LTD., Kanagawa (JP)

(72) Inventors: Shinya UI, Tokyo (JP); Azusa OZAWA, Tokyo (JP); Taku FUKUMURA, Kanagawa (JP)

(21) Appl. No.: 19/245,766

(22) Filed: Jun. 23, 2025

Related U.S. Application Data
(63) Continuation of application No. PCT/JP2024/024561, filed on Jul. 8, 2024.

(30) Foreign Application Priority Data
Jul. 19, 2023 (JP) 2023-117849

(51) Int. Cl. B08B 9/032; B01D 3/06; B01D 19/00; B01D 21/26; F24T 10/20; F24T 50/00; F28F 19/01

(52) U.S. Cl. CPC B08B 9/0325; B01D 3/06; B01D 19/0057; B01D 21/267; F24T 50/00; F28F 19/01; B08B 2209/032; F24T 10/20

(57) ABSTRACT

A geothermal power generation system includes a binary power generator provided with a medium evaporator. The geothermal power generation system includes: gas-liquid separator to separate geothermal brine from a geothermal fluid spouted out from a production well; first pipe to send the geothermal brine separated by the gas-liquid separator to the medium evaporator; first valve provided inside the first pipe and to open and close a flow path of the first pipe; second pipe to send the geothermal brine, from which heat has been recovered by the binary power generator, from the medium evaporator to a re-injection well; analyzer to intake the geothermal brine flowing through the second pipe and to analyze components of a scale contained in incoming geothermal brine; and controller to determine at least one detergent from a plurality of detergent candidates, based on an analysis result of the analyzer, and to control supply of the detergent.

### CROSS-REFERENCE TO RELATED APPLICATIONS

This application is a continuation application of International Application No. PCT/JP2024/024561, filed on Jul. 8, 2024, and designated the U.S., which is based upon and claims priority to Japanese Patent Application No. 2023-117849, filed on Jul. 19, 2023, the entire contents of which are incorporated herein by reference.

### BACKGROUND

### 1. Field of the Invention

The present disclosure relates to a geothermal power generation system.

### 2. Description of the Related Art

A geothermal power generation system extracts high-temperature geothermal fluid (geothermal brine and geothermal steam) from a production well, and generates power by using steam separated from the geothermal fluid. The geothermal fluid extracted from the production well contains more calcium, dissolved silica, and the like than well water and river water.

Dissolved silica in geothermal brine collected from the production well is concentrated by decompression in the geothermal power generation system, and it is cooled as it flows through piping, and thus, the solubility of the dissolved silica decreases. Then, when the calcium, the dissolved silica, or the like contained in the geothermal brine become supersaturated, they polymerize into calcium carbonate, amorphous silica, etc., and precipitate as scale. Adhesion of the scale inside the piping is an issue in the geothermal power generation system, because the scale adhered to an inner wall or the like of the piping may cause such as blockage of the piping.

In particular, in a binary geothermal power generation system, sufficient cleaning away of the scale is required. For example, in the binary geothermal power generation system disclosed in Japanese Laid-Open Patent Application No. 2015-90147, hydrogen peroxide water is supplied to the geothermal brine as an oxidizing agent on an upstream side relative to an evaporator in a geothermal brine ejection line to prevent scale adhesion of silica components in a geothermal brine system.

### SUMMARY

An embodiment of the present disclosure is a geothermal power generation system including a binary power generator provided with a medium evaporator, including: a gas-liquid separator configured to separate geothermal brine from a geothermal fluid spouted out from a production well; a first pipe configured to send the geothermal brine separated by the gas-liquid separator to the medium evaporator; a first valve provided inside the first pipe and configured to open and close a flow path of the first pipe; a second pipe configured to send the geothermal brine, from which heat has been recovered by the binary power generator, from the medium evaporator to a re-injection well; an analyzer configured to intake the geothermal brine flowing through the second pipe and to analyze components of a scale contained in incoming geothermal brine; and a controller configured to determine at least one detergent from a plurality of detergent candidates, based on an analysis result of the analyzer, and to control supply of the detergent, wherein the first pipe includes a detergent supply port from which the detergent is supplied on a downstream side relative to the first valve.

### BRIEF DESCRIPTION OF THE DRAWINGS

FIG. 1 is a schematic configurational diagram illustrating a geothermal power generation system according to an embodiment;

FIG. 2 is a schematic diagram illustrating a separation vessel; and

FIG. 3 is a flow diagram illustrating how cleaning is performed according to the embodiment.

### DETAILED DESCRIPTION OF THE PRESENT DISCLOSURE

The scale contained in the geothermal brine in the geothermal power generation system contains a plurality of components such as silica components, calcium components, ooze, iron rust, etc., and the composition of the scale varies depending on each power plant. Also, even in the same power plant, the scale may change over time during a long-term operation. Therefore, in a conventional geothermal power generation system, there has been an issue in which the scale containing silica as a main component can be cleaned, but the scale containing other components as a main component cannot be cleaned sufficiently, thereby resulting in poor cleaning.

A geothermal power generation system capable of removing scale regardless of the components of the scale is provided.

Hereinafter, an embodiment of the present disclosure will be described with reference to the drawings.

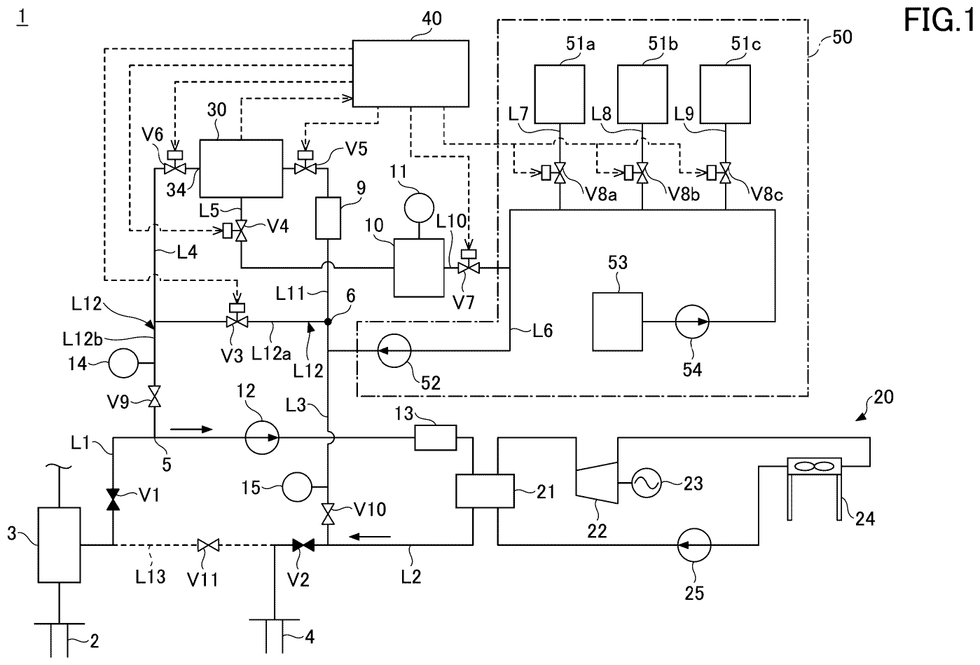

FIG. 1 is a schematic configurational diagram illustrating a geothermal power generation system 1 according to an embodiment. As illustrated in FIG. 1, the geothermal power generation system 1 includes a binary power generator 20 provided with a medium evaporator 21. Furthermore, the geothermal power generation system 1 includes a gas-liquid separator 3, a first pipe L1 configured to send the geothermal brine separated by the gas-liquid separator 3 to the medium evaporator 21, a first valve V1 provided inside the first pipe L1 to open and close a flow path of the first pipe L1, and a second pipe L2 configured to send the geothermal brine, from which heat has been recovered by the binary power generator 20, from the medium evaporator 21 to a re-injection well 4. Furthermore, the geothermal power generation system 1 includes an analyzer 30 and a controller 40. Furthermore, the first pipe L1 includes a detergent supply port 5 configured to supply the detergent on the downstream side of the first valve V1.

The geothermal power generation system 1 performs binary power generation in the binary power generator 20 by utilizing the heat of the geothermal brine separated by the gas-liquid separator 3. In the geothermal power generation system 1, geothermal fluid collected from a production well 2 is sent to the gas-liquid separator 3. The gas-liquid separator 3 separates the geothermal brine from the geothermal fluid spouted out from the production well 2. The geothermal brine separated by the gas-liquid separator 3 is sent to the medium evaporator 21 via the first pipe L1, where heat is exchanged to evaporate a low-boiling-point heat medium, and then returned to the re-injection well 4 via the second pipe L2.

The heat medium vaporized by the medium evaporator 21 is sent to a turbine 22 via a pipe, and power is generated by a power generator 23. Furthermore, the heat medium that has passed through the turbine 22 is sent to a medium condenser 24 via a pipe, where it becomes a condensate and is returned to the medium evaporator 21 via a pipe including therein a pump 25.

The heat medium used in the binary power generator 20 is a low-boiling-point heat medium that can be vaporized by utilizing the heat of the geothermal brine separated by the gas-liquid separator 3. Examples of the heat medium include, but are not limited to, normalheptane, isoheptane, normalpentane, isopentane, normalbutane, isobutane, hydrofluoroether, 1,1,1,3,3-pentafluoropropane (R245fa), 1,1,1,2-tetrafluoroethane (R134a), chlorodifluoromethane (R22), as well as a mixture of difluoromethane, 1,1,1,2-pentafluoroethane, and 1,1,1,2-tetrafluoroethane (R407c).

In contrast to this, the geothermal steam separated by the gas-liquid separator 3 may be sent to a turbine (not illustrated) and power may be generated by a power generator connected to the turbine. In this case, the gas-liquid separator 3 has a function of a flasher to decompress the geothermal brine and extract the geothermal steam. That is, the geothermal power generation system 1 may include a flash power generator (not illustrated) connected to the gas-liquid separator 3 and the binary power generator 20.

The geothermal power generation system 1 may include a thirteenth pipe L13 branched from the first pipe L1 and connected to the re-injection well 4, and a bypass valve V11 provided inside the thirteenth pipe L13.

The geothermal power generation system 1 may include a second valve V2 provided inside the second pipe L2 and configured to open and close a flow path of the second pipe L2, a third pipe L3 connected to the second pipe L2 on an upstream side relative to the second valve V2, and a branching section 6 configured to branch the flow of the geothermal brine or the detergent flowing through the third pipe L3 into an analysis line L11 connected to the analyzer 30 and a detergent supply line L12 connected to the detergent supply port 5. The geothermal power generation system 1 may also include a detergent addition device 50 configured to add a detergent to the geothermal brine flowing through the third pipe L3. FIG. 1 is a diagram illustrating a state in which the first valve V1 and the second valve V2 are closed.

An inner diameter of the analysis line L11 is smaller than the inner diameter of the detergent supply line L12. Thus, the geothermal brine of an appropriate flow rate for analysis, which is smaller than the flow rate of the geothermal brine flowing into the analysis line L11, can be introduced into the analyzer 30 via the analysis line L11, and the detergent of the flow rate necessary for cleaning can be introduced into the detergent supply line L12.

The geothermal power generation system 1 may include a circulation pump 12 provided inside the first pipe L1 on the downstream side relative to the detergent supply port 5. The circulation pump 12 has a function of sending the geothermal brine separated by the gas-liquid separator 3 to the second pipe L2 during ordinary operation (during power generation), and has a function of circulating the detergent supplied from the detergent supply port 5, together with the geothermal brine, into the flow path including the first pipe L1, the second pipe L2, the third pipe L3, and the detergent supply line L12 during cleaning performed after the ordinary operation (after stoppage of the power generation).

It is preferable that the geothermal power generation system 1 further includes a third valve V3 provided in the detergent supply line L12 and configured to open and close the flow path of the detergent supply line L12. Specifically, the detergent supply line L12 includes a first detergent supply line L12a which branches from the branching section 6, and a second detergent supply line L12b which has one end connected to the first detergent supply line L12a and the other end connected to the detergent supply port 5. The third valve V3 is provided in the first detergent supply line L12a.

The geothermal power generation system 1 may include a fourth pipe L4 having one end connected to a first outlet 34 of the analyzer 30 and the other end connected to the second detergent supply line L12b, and configured to circulate the geothermal brine discharged from the analyzer 30.

The analyzer 30 takes in the geothermal brine flowing through the second pipe L2, and analyzes scale components contained in the inflow geothermal brine. Examples of the scale components contained in the geothermal brine include amorphous silica, calcium carbonate, ooze containing organic matter, iron rust, and the like.

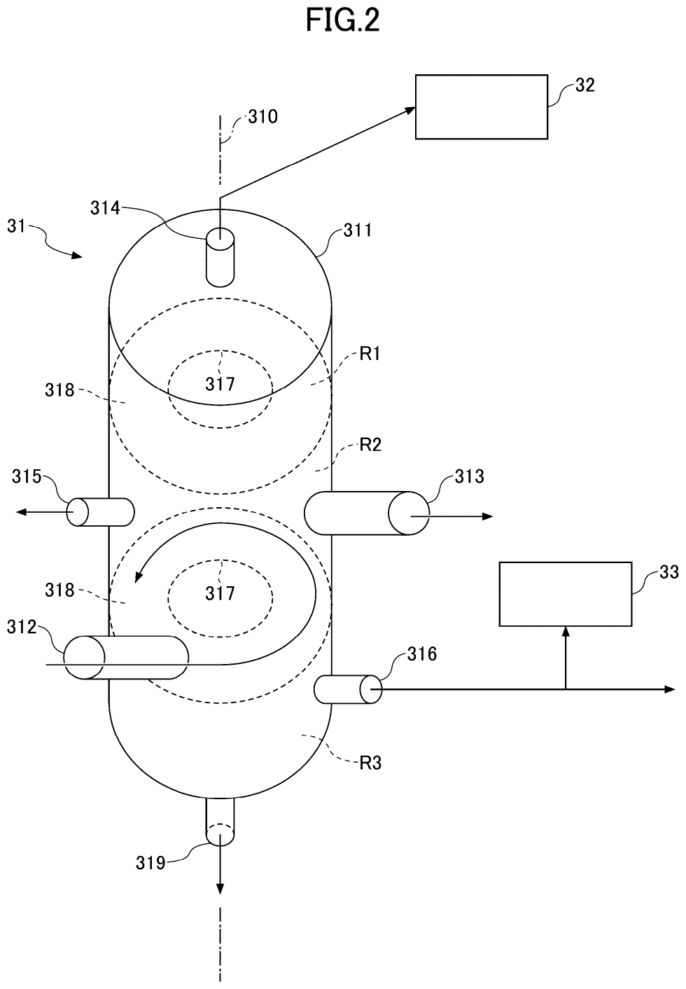

As illustrated in FIG. 2, the analyzer 30 may include a separation vessel 31 configured to separate solid substances, liquid, and gas contained in the geothermal brine flowing into the analyzer 30, a gas analyzer 32 configured to analyze the separated gas from the separation vessel 31, and a liquid analyzer 33 configured to analyze the separated liquid from the separation vessel 31.

The separation vessel 31 may separate solid substances, liquid, and gas contained in the geothermal brine by generating a swirling flow inside the separation vessel 31. In FIG. 2, the flow of solid substances, liquid, and gas contained in the geothermal brine is indicated by arrows. Specifically, the separation vessel 31 may include a housing 311 having a cylindrical shape and arranged such that an axis 310 of the housing 311 is at an angle within a range of 0° or more and less than 90° with respect to a vertical direction, a geothermal brine inlet 312 provided on a side surface of the housing 311 and through which the geothermal brine flows in, and a geothermal brine outlet 313 through which the geothermal brine is discharged.

The geothermal brine inlet 312 is connected to the analysis line L11, and the geothermal brine outlet 313 is connected to the fourth pipe L4. The geothermal power generation system 1 may include a fifth valve V5 provided in the analysis line L11 to open and close the flow path of the analysis line L11, and a sixth valve V6 provided inside the fourth pipe L4 to open and close a flow path of the fourth pipe L4.

The geothermal power generation system 1 may include a flowmeter 9 provided in the analysis line L11 and configured to measure the flow rate of geothermal brine flowing into the analyzer 30.

The inside of the separation vessel 31 may be divided into three chambers. For example, the separation vessel 31 may include a first chamber R1, a second chamber R2, and a third chamber R3 arranged adjacently from an upper side in the vertical direction. The first chamber R1, the second chamber R2, and the third chamber R3 communicate with each other at their central portions. Specifically, the separation vessel 31 may include two partitions 318 including an opening 317 at each center, and the partitions 318 may be spaced apart from each other along the axis 310 inside the housing 311. A central axis of the opening 317 coincides with the axis 310 of the housing 311. The partition 318 may be, for example, a baffle.

The first chamber R1 includes on an upper surface of the first chamber R1 a gas outlet 314 for discharging the separated gas. The second chamber R2 includes on a side surface thereof a first solid-substance outlet 315 for discharging the separated solid substances. The third chamber R3 includes on a lower surface thereof, that is a bottom surface of the separation vessel 31, a second solid-substance outlet 319 for discharging the separated solid substances, and includes on a side surface thereof a liquid outlet 316 for discharging the separated liquid.

The solid substances discharged from the first solid-substance outlet 315 include solid substances having a relatively large mass such as, for example, rock fragments and iron rust, and the solid substances discharged from the second solid-substance outlet 319 include solid substances having a smaller mass than the solid substances discharged from the first solid-substance outlet 315, such as ooze and colloids.

The geothermal brine inlet 312 and the geothermal brine outlet 313 are provided on the side surface of the second chamber R2, and the geothermal brine inlet 312 is arranged on a lower side relative to the geothermal brine outlet 313 in a vertical direction. With the above configuration, the separation vessel 31 can separate solid substances, liquid, and gas contained in the geothermal brine by generating a swirling flow inside the separation vessel 31.

The gas analyzer 32 is connected to the gas outlet 314 of the separation vessel 31. The gas analyzer 32 measures, for example, the concentration of oxygen and the concentration of carbon dioxide.

The liquid analyzer 33 is connected to the liquid outlet 316 of the separation vessel 31. The liquid analyzer 33 measures, for example, a pH level, a dielectric constant, and a dissolved ion concentration.

The separation vessel 31 has the function of separating solid substances, liquid, and gas contained in the geothermal brine as described above, and also has the function of collecting or depositing scales in the separation vessel 31 for analysis. Therefore, in order to accelerate the collection or the deposition of scales in the separation vessel 31, the separation vessel 31 may include a metal mesh, ceramic beads, or the like inside.

As illustrated in FIG. 1, the geothermal power generation system 1 may include a recovery tank 10 connected to the first solid-substance outlet 315 (see FIG. 2) and the second solid-substance outlet 319 (see FIG. 2) of the analyzer 30 and accommodating solid substances discharged from the first solid-substance outlet 315 and the second solid-substance outlet 319.

The geothermal power generation system 1 may include a fourth valve V4 provided in a flow path connecting the first solid-substance outlet 315 and the second solid-substance outlet 319 to the recovery tank 10. Specifically, the geothermal power generation system 1 may include a fifth pipe L5 connecting the first solid-substance outlet 315 and the second solid-substance outlet 319 to the inlet of the recovery tank 10, and a fourth valve V4 provided inside the fifth pipe L5 to open and close the flow path of the fifth pipe L5. The solid substances discharged from the first solid-substance outlet 315 and the second solid-substance outlet 319 flow into and are accommodated in the recovery tank 10 via the fifth pipe L5.

The recovery tank 10 may include a water level meter 11. Thus, the amount of solid substances accommodated in the recovery tank 10 can be detected, and when the amount detected by the water level meter 11 reaches a specified value, the solid substances in the recovery tank 10 can be disposed of.

The controller 40 determines at least one detergent from a plurality of detergent candidates, based on the analysis result of the analyzer 30, and controls the supply of the detergent. The plurality of detergent candidates can be, for example, chemical agents containing two or more agents selected from a group including acidic agents, basic agents, chelating agents, hydrogen peroxide agents, dispersants, and catalase agents.

The acidic agents can be used to dissolve calcium-based scales. Examples of the acidic agents include sulfuric acid, hydrochloric acid, acetic acid, citric acid, and the like. The basic agents can be used to dissolve silica-based scales (amorphous silica). Examples of the basic agents include sodium hydroxide, potassium hydroxide, ammonium salts, and the like. The chelating agents can be used to perform masking of dissolved metals in the geothermal brine and to suppress waste of other detergents before using other detergents under pH control. Examples of the chelating agents include ethylenediaminetetraacetic acid (EDTA), nitrilotriacetic acid (NTA), hydroxyethylenediaminetriacetic acid (HEDTA), diethylenetriaminepentaacetic acid (DTPA), trimethanolamine, sodium gluconate, and the like. Hydrogen peroxide agents can be used to dissolve ooze. For example, hydrogen peroxide solution is used as the hydrogen peroxide agent. The dispersant can be used to disperse and peel off the scale adhered to an inner wall or the like of piping. For example, sodium polyacrylate, various surfactants, and the like are used as the dispersant. The catalase agent can be used to decompose the hydrogen peroxide agent remaining in the geothermal brine after using the hydrogen peroxide agent.

Specifically, the controller 40 determines at least one detergent from a plurality of detergent candidates, based on the gas analysis result of the analyzer 30, and controls the supply of the detergent. For example, the controller 40 determines that the main component of the scale is ooze when the concentration of oxygen detected by the gas analyzer 32 after introducing the hydrogen peroxide agent into the separation vessel 31 of the analyzer 30 and reacting the hydrogen peroxide agent with the scale deposited in the separation vessel 31 is equal to or greater than a specified value, and determines that the main component of the scale is calcium carbonate or amorphous silica when the concentration of oxygen detected by the gas analyzer 32 is equal to or less than the specified value. When the main component of the scale is determined to be calcium carbonate or amorphous silica, the controller 40 determines that the main component of the scale is calcium carbonate when the concentration of carbon dioxide detected by the gas analyzer 32 is equal to or greater than the specified value after introducing the acidic agent into the separation vessel 31 and reacting the acidic agent with the scale deposited in the separation vessel 31, and determines that the main component of the scale is amorphous silica or iron rust when the concentration of carbon dioxide detected by the gas analyzer 32 is equal to or less than the specified value. The optimum detergent is determined for the main component of the scale determined as described above from the plurality of detergent candidates.

Before determining the detergent, the controller 40 may cause the analysis line L11 and the analyzer 30 to take-in the geothermal brine with the fourth valve V4 closed and to collect the separated solid substances in the separation vessel 31, and then may close the first valve V1, the second valve V2, and the third valve V3, and may cause the detergent addition device 50 to supply the acidic agent or the hydrogen peroxide agent to the analysis line L11, and the analyzer 30 may analyze the gas generated by the chemical reaction of the solid substance with respect to the acidic agent or the hydrogen peroxide agent. Furthermore, when the main component of the scale is ooze, the controller 40 may select the hydrogen peroxide agent as a first detergent to be used, and may select a detergent other than the hydrogen peroxide agent as a second detergent to be used. When the main component of the scale is calcium carbonate, the controller 40 may select the acidic agent as the first detergent to be used, and may select a detergent other than the acidic agent as the second detergent to be used.

The detergent addition device 50 may include a plurality of chemical agent tanks 51a, 51b, and 51c each configured to accommodate one of a plurality of detergent candidates, a chemical agent injection pump 52 configured to introduce the detergent into the third pipe L3, a water tank 53 arranged on an upstream side relative to the plurality of chemical agent tanks 51a, 51b, and 51c and configured to store water, and a liquid feed pump 54 configured to introduce the water into the third pipe L3. The number of the chemical agent tanks 51a, 51b, 51c is three in the example as illustrated in FIG. 1, but is not limited thereto, and may be four or more depending on the number of detergent candidates.

The water contained in the water tank 53 may be water for washing away the detergent remaining in a sixth pipe L6 when changing the type of detergent to be introduced to the third pipe L3, and may be, for example, one kind selected from a group including tap water, river water, and distilled water.

The detergent addition device 50 may include the sixth pipe L6 that connects an outlet port of the liquid feed pump 54 and an inlet port of the chemical agent injection pump 52, a seventh pipe L7 that is branched from the sixth pipe L6 and connected to an outlet of the chemical agent tank 51a, an eighth pipe L8 that is branched from the sixth pipe L6 and connected to an outlet of the chemical agent tank 51b, and a ninth pipe L9 that is branched from the sixth pipe L6 and connected to an outlet of the chemical agent tank 51c. The detergent addition device 50 may include an eighth valve V8a provided inside the seventh pipe L7 to open and close a flow path of the seventh pipe L7, an eighth valve V8b provided inside the eighth pipe L8 to open and close a flow path of the eighth pipe L8, and an eighth valve V8c provided inside the ninth pipe L9 to open and close a flow path of the ninth pipe L9.

On the downstream side relative to the seventh pipe L7, the eighth pipe L8, and the ninth pipe L9, the detergent addition device 50 may include a tenth pipe L10 connected to a detergent inlet of the recovery tank 10, and a seventh valve V7 provided inside the tenth pipe L10 to open and close a flow path of the tenth pipe L10. The detergent addition device 50 can introduce the detergent into the detergent inlet of the recovery tank 10 via the tenth pipe L10. The solid substances contained in the recovery tank 10 can be dissolved by introducing the detergent from the detergent inlet of the recovery tank 10. The detergent introduced from the detergent inlet of the recovery tank 10 is preferably a detergent capable of dissolving solid substances such as ooze and colloids. Examples include hydrogen peroxide agents, basic agents, fluoride agents, and mixtures of chelating agents and basic agents. The basic agents and fluoride agents can be used to dissolve silica-based colloids. As the basic agent, the same chemical agents as the above-mentioned detergent candidates can be used. Examples of the fluoride agent include hydrofluoric acids. A mixture of a chelating agent and a basic agent can be used to dissolve calcium-based colloids. As the chelating agent, the same chemical agent as the detergent candidate can be used.

The recovery tank 10 may have a function of adjusting the pressure. Specifically, when excessive pressure exceeding a specified value is applied to the chemical agent injection pump 52 by the detergent or water flowing through the sixth pipe L6, the controller 40 sends a signal to the seventh valve V7 to open the seventh valve V7. Thus, the detergent or water flowing through the sixth pipe L6 can flow into the recovery tank 10 through the tenth pipe L10, thereby reducing the pressure on the chemical agent injection pump 52.

The geothermal power generation system 1 is preferably provided with a heater or a heat exchanger or the like from the viewpoint of enhancing the effect of the detergent by raising the temperature of the fluid when the temperature of the geothermal brine to which the detergent is to be added drops or the like. The heater or the heat exchanger may be provided, for example, inside the first pipe L1 on the downstream side relative to the detergent supply port 5.

The controller 40 may be configured to determine a cleaning state based on an analysis result of the components contained in the fluid analyzed by the analyzer 30, after distributing the fluid, which is obtained by adding the detergent to the geothermal brine flowing through the third pipe L3 by the detergent addition device 50, through the detergent supply line L12, the first pipe L1, the second pipe L2, and the third pipe L3. As the cleaning proceeds, the inner wall of the piping is exposed, and the iron of the piping dissolves into the fluid, and thus, the concentration of iron ions contained in the fluid increases. Therefore, the analysis result of the components contained in the fluid analyzed by the analyzer 30 may be the concentration of the iron ions. For example, the controller 40 may determine that the cleaning is complete when the concentration of the iron ions reaches 100 ppm. The analysis result of the components contained in the fluid analyzed by the analyzer 30 may be a dielectric constant.

The geothermal power generation system 1 includes a pressure gauge 14 provided inside the second detergent supply line L12b and a pressure gauge 15 provided inside the third pipe L3. The controller 40 may determine that the cleaning is complete when a differential pressure between the pressure detected by the pressure gauge 14 and the pressure detected by the pressure gauge 15 becomes less than or equal to a specified value. When the scale adheres to the inner walls of the first pipe L1 and the second pipe L2, a cross-sectional area of a flow path decreases in both the first pipe L1 and the second pipe L2. Therefore, the state of the cleaning can be determined based on the differential pressure between the pressure gauge 14 located on the upstream side relative to both the first pipe L1 and the second pipe L2 and the pressure gauge 15 located on the downstream side relative to both the first pipe L1 and the second pipe L2.

The geothermal power generation system 1 includes a flowmeter 13 provided inside the first pipe L1 on the downstream side relative to the circulation pump 12. The controller 40 may determine that the cleaning is complete when the flow rate detected by the flowmeter 13 reaches the flow rate occurring at the start of operation (start of power generation) or a specified flow rate.

The geothermal power generation system 1 may include a ninth valve V9 provided inside the second detergent supply line L12b and a tenth valve V10 provided inside the third pipe L3. The ninth valve V9 and the tenth valve V10 may be flow adjustment valves.

The controller 40 can control each of the first valve V1 to the seventh valve V7, the eighth valves V8a, V8b, and V8c, the ninth valve V9, the tenth valve V10, and the bypass valve V11, and can switch the flow path in the geothermal power generation system 1 or control the flow rate of the fluid flowing through the flow path.

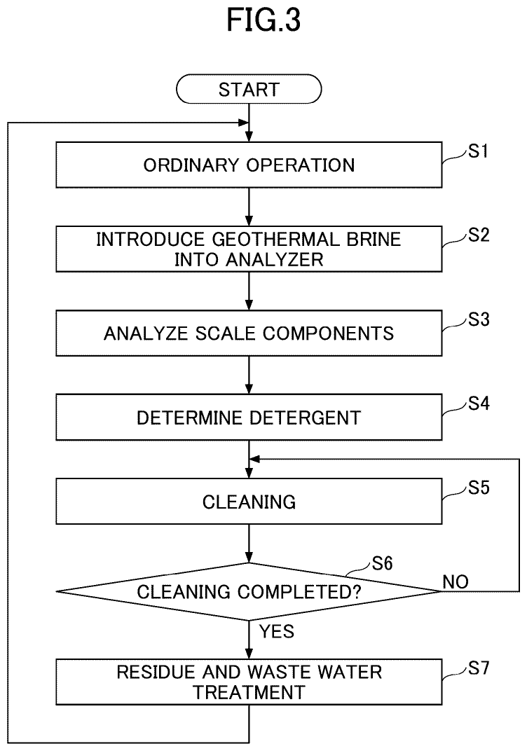

As illustrated in FIG. 3, a method for cleaning the scale in the geothermal power generation system 1 includes performing an ordinary operation (step S1), introducing the geothermal brine into the analyzer 30 after the ordinary operation (step S2), analyzing scale components contained in the introduced geothermal brine by the analyzer 30 (step S3), determining at least one detergent from a plurality of detergent candidates, based on an analysis result of the analyzer 30 (step S4), and cleaning the first pipe L1 and the second pipe L2 by supplying the determined detergent from the detergent supply port 5 (step S5).

In the method of cleaning the scale in the geothermal power generation system 1, step S3 is preferably performed 2 to 3 weeks after the start of step S2, in order to collect or deposit the scale required for the analysis in step S3, inside the analyzer 30.

The method for cleaning the scale in the geothermal power generation system 1 further includes determining (step S6) whether or not the cleaning is complete (cleaning state) based on the analysis result of the analyzer 30, which is obtained by introducing the fluid (including the geothermal brine and the detergent) after cleaning the first pipe L1 and the second pipe L2 into the analyzer 30 and analyzing the components contained in the introduced fluid by the analyzer 30. When the cleaning is determined to be complete (“YES” in step S6), a treatment of residues and waste water (step S7) is performed and a process flow returns to the ordinary operation (step S1). When the cleaning is determined not to be complete (“NO” in step S6), the process flow returns to step S5 and the steps S5 and S6 may be repeated until the cleaning is determined to be complete.

When performing the treatment of the residues and the waste water, the geothermal power generation system 1 collects the residues such as rock fragments and iron rust in the fluid before draining the fluid after the cleaning, and discards the residues as industrial waste. Before draining the fluid, it is preferable to add an acidic agent or a basic agent to the fluid after removal of the residues and adjust the pH level of the fluid to the same level as that of the geothermal brine before the cleaning. In adjustment of the pH level of the fluid to the same level as that of the geothermal brine before the cleaning, when organic precipitates are generated, it is preferable to add a hydrogen peroxide agent to decompose the organic precipitates, and then drain the fluid. When an organic solvent remains in the cleaned fluid after removing the residues, it is preferable to distil the fluid, and then drain the fluid.

The geothermal power generation system 1 is a geothermal power generation system including the binary power generator 20 provided with the medium evaporator 21, and includes the gas-liquid separator 3, the first pipe L1, the first valve V1, the second pipe L2, the analyzer 30, and the controller 40, and the first pipe L1 includes the detergent supply port 5.

With this configuration, the geothermal power generation system 1 can supply an optimum detergent according to the components of the scale from the detergent supply port 5, and can distribute the detergent to the first pipe L1 and the second pipe L2, where the scale is particularly likely to adhere, in a state in which the power generation is stopped by closing the first valve V1, and in a state in which the geothermal power generation system 1 is closed, that is, in a state not opened to an external environment or decomposed. Therefore, the geothermal power generation system 1 can remove the scale regardless of the components of the scale. In addition, the geothermal power generation system 1 can add a detergent to the geothermal brine having a relatively high temperature after power generation is stopped and distribute the detergent to the first pipe L1 and the second pipe L2, thereby enhancing the effect of the detergent.

The geothermal power generation system 1 includes the second valve V2, the third pipe L3, the branching section 6 which can branch the flow path of the third pipe L3 into the analysis line L11 and the detergent supply line L12, and the detergent addition device 50.

With this configuration, the geothermal power generation system 1 can introduce the geothermal brine flowing through the second pipe L2 into the analyzer 30 through the analysis line L11 in a closed state without opening or decomposing the geothermal power generation system 1. In addition, the first valve V1 and the second valve V2 are closed, and the optimum detergent corresponding to the components of the scale is added to the geothermal brine flowing through the third pipe L3, and the detergent is distributed from the detergent supply port 5 to the first pipe L1 and the second pipe L2 through the detergent supply line L12, thereby cleaning the first pipe L1 and the second pipe L2.

The geothermal power generation system 1 includes the third valve V3. Thus, by closing the third valve V3, the geothermal brine or the detergent flowing through the third pipe L3 can be distributed only to the analysis line L11, such that the scale components contained in the geothermal brine can be analyzed by the analyzer 30 before the detergent is distributed to the detergent supply line L12.

The geothermal power generation system 1 includes the fourth pipe L4. Thereby, the geothermal brine discharged from the first outlet 34 of the analyzer 30 can be supplied to the first pipe L1 from the detergent supply port 5 via the detergent supply line L12 and be utilized for binary power generation.

The geothermal power generation system 1 includes the flowmeter 9, and the analyzer 30 includes the separation vessel 31, the gas analyzer 32, and the liquid analyzer 33. Thus, the geothermal power generation system 1 can adjust the flow rate of the geothermal brine flowing into the analysis line L11 to be smaller with respect to the flow rate of the geothermal brine flowing into the detergent supply line L12, separate the geothermal brine into solid substances, liquid, and gas in the separation vessel 31, and analyze the separated gas by the gas analyzer 32 and the separated liquid by the liquid analyzer 33. Thus, the analyzer 30 can determine the optimum detergent according to the components of the scale contained in the geothermal brine.

In the geothermal power generation system 1, the controller 40 determines at least one detergent from a plurality of detergent candidates, based on the gas analysis results of the analyzer 30, and controls the supply of the detergent. With this configuration, the detergent is introduced into the separation vessel 31 of the analyzer 30, the scale deposited inside the separation vessel 31 is reacted with the detergent, and the components contained in the scale can be determined based on the gas analysis results of the generated gas. Therefore, the analyzer 30 can determine the optimum detergent according to the components of the scale contained in the geothermal brine.

In the geothermal power generation system 1, the gas analyzer 32 measures the concentration of oxygen and the concentration of carbon dioxide. Thus, the controller 40 can determine whether or not the components contained in the scale are ooze, calcium carbonate, amorphous silica, or iron rust based on the concentration of oxygen and the concentration of carbon dioxide after introducing the hydrogen peroxide agent or the acidic agent into the separation vessel 31 of the analyzer 30 and reacting the hydrogen peroxide agent or the acidic agent with the scale deposited inside the separation vessel 31. Therefore, the controller 40 can determine the optimum detergent according to the components of the scale contained in the geothermal brine.

In the geothermal power generation system 1, the liquid analyzer 33 measures the pH level, the dielectric constant, and the dissolved ion concentration. Thus, the controller 40 can remove the scale by causing the liquid analyzer 33 to detect the pH level of the fluid introduced into the analyzer 30 and, based on the detected pH level, controlling the supply of the acidic agent or the basic agent to the fluid such that the pH level becomes the pH level required to dissolve the scale. When the chelating agent is used as the detergent, the pH level of the fluid can be adjusted by causing the liquid analyzer 33 to detect the pH level of the fluid and, based on the detected pH level, controlling the supply of the acidic agent or the basic agent to the fluid such that the pH level is appropriate. In addition, the controller 40 can determine the cleaning state based on the detected dielectric constant or the dissolved ion concentration by causing the liquid analyzer 33 to detect the dielectric constant or the dissolved ion concentration of the fluid introduced into the analyzer 30. Thus, the geothermal power generation system 1 can sufficiently remove the scale regardless of the scale components.

In the geothermal power generation system 1, the separation vessel 31 generates a swirling flow inside the separation vessel 31 to separate solid substances, liquid, and gas contained in the geothermal brine. Thus, the geothermal power generation system 1 can efficiently analyze the scale components contained in geothermal brine by the analyzer 30.

In the geothermal power generation system 1, the separation vessel 31 has a cylindrical shape, includes the housing 311, the geothermal brine inlet 312, the geothermal brine outlet 313, the first chamber R1, the second chamber R2, and the third chamber R3; the first chamber R1, the second chamber R2, and the third chamber R3 communicate at a central portion thereof; the first chamber R1 includes the gas outlet 314, the second chamber R2 includes the first solid-substance outlet 315, the third chamber R3 includes the second solid-substance outlet 319 and the liquid outlet 316; and the geothermal brine inlet 312 is arranged on the lower side, in a vertical direction, relative to the geothermal brine outlet 313.

With the above configuration, the separation vessel 31 can efficiently separate solid substances, liquid, and gas contained in the geothermal brine by generating a swirling flow inside the separation vessel 31. Therefore, the geothermal power generation system 1 can efficiently analyze the scale components contained in the geothermal brine by the analyzer 30.

In the geothermal power generation system 1, the geothermal power generation system 1 includes the recovery tank 10. Thus, the geothermal power generation system 1 can remove solid substances unnecessary for the analysis by the analyzer 30.

In the geothermal power generation system 1, the detergent addition device 50 includes the plurality of chemical agent tanks 51a, 51b, 51c, the chemical agent injection pump 52, the water tank 53, and the liquid feed pump 54. Therefore, the geothermal power generation system 1 can supply the optimum detergent according to the components of the scale from the detergent supply port 5 among the plurality of detergent candidates. Therefore, the geothermal power generation system 1 can remove the scale regardless of the components of the scale.

In the geothermal power generation system 1, the plurality of detergent candidates include two or more kinds selected from a group including acidic agents, basic agents, chelating agents, hydrogen peroxide agents, dispersants, and catalase agents. Thus, the geothermal power generation system 1 can supply the optimum detergent for each of ooze, calcium carbonate, amorphous silica, and iron rust contained in the scale from the detergent supply port 5.

In the geothermal power generation system 1, the fourth valve V4 is included; the controller 40 causes the analysis line L11 and the analyzer 30 to take-in the geothermal brine with the fourth valve V4 closed, before determining a detergent, and to collect the separated solid substances in the separation vessel 31, closes the first valve V1, the second valve V2, and the third valve V3, and causes the detergent addition device 50 to supply the acidic agent or the hydrogen peroxide agent to the analysis line L11; and the analyzer 30 analyzes the gas generated by a chemical reaction between the solid substances and the acidic agent or the hydrogen peroxide agent.

In the geothermal power generation system 1, the controller 40 can determine the cleaning state based on the analysis result of the components contained in the fluid analyzed by the analyzer 30 after the fluid in which the detergent has been added to the geothermal brine flowing through the third pipe L3 is circulated to the detergent supply line L12, the first pipe L1, the second pipe L2, and the third pipe L3 by the detergent addition device 50. Therefore, the geothermal power generation system 1 can sufficiently remove the scale regardless of the components of the scale.

In the geothermal power generation system 1, the water stored in the water tank is one kind selected from a group including tap water, river water, and distilled water. Thus, even when the geothermal brine in the first pipe L1 and the second pipe L2 is drained before cleaning, the geothermal power generation system 1 can introduce the water stored in the water tank into the third pipe L3 together with the detergent, and supply it to the first pipe L1 from the detergent supply port 5 through the detergent supply line L12.

According to the geothermal power generation system according to an embodiment of the present disclosure, scale can be removed regardless of the components of the scale.

Although the embodiments have been described as above, the above embodiments are presented as an example, and the present invention is not limited by the above embodiments. The above embodiments can be implemented in various other forms, and various combinations, omissions, substitutions, changes, and the like can be made without departing from the gist of the invention. These embodiments and variations thereof are included in the scope and gist of the invention, as well as in the scope and equivalence of the claimed invention.

What is claimed is:

1. A geothermal power generation system including a binary power generator provided with a medium evaporator, the geothermal power generation system comprising:
a gas-liquid separator configured to separate geothermal brine from a geothermal fluid spouted out from a production well;
a first pipe configured to send the geothermal brine separated by the gas-liquid separator to the medium evaporator;
a first valve provided inside the first pipe and configured to open and close a flow path of the first pipe;
a second pipe configured to send the geothermal brine, from which heat has been recovered by the binary power generator, from the medium evaporator to a re-injection well;
an analyzer configured to intake the geothermal brine flowing through the second pipe and to analyze components of a scale contained in incoming geothermal brine; and
a controller configured to determine at least one detergent from a plurality of detergent candidates, based on an analysis result of the analyzer, and to control supply of the detergent, wherein
the first pipe includes a detergent supply port from which the detergent is supplied on a downstream side relative to the first valve.

2. The geothermal power generation system according to claim 1, further comprising:
a second valve provided inside the second pipe and configured to open and close a flow path of the second pipe;
a third pipe connected to the second pipe on an upstream side relative to the second valve;
a branching section configured to branch a flow of the geothermal brine or the detergent flowing through the third pipe into an analysis line connected to the analyzer and a detergent supply line connected to the detergent supply port; and
a detergent addition device configured to add the detergent to the geothermal brine flowing through the third pipe.

3. The geothermal power generation system according to claim 2, further comprising:
a third valve provided in the detergent supply line and configured to open and close a flow path of the detergent supply line.

4. The geothermal power generation system according to claim 3, further comprising:
a fourth pipe having one end connected to a first outlet of the analyzer and another end connected to the detergent supply line, and configured to circulate the geothermal brine discharged from the analyzer.

5. The geothermal power generation system according to claim 4, further comprising:
a flowmeter provided in the analysis line and configured to measure a flow rate of the geothermal brine flowing into the analyzer, wherein
the analyzer includes
a separation vessel configured to separate solid substances, liquid, and gas contained in the geothermal brine flowing into the analyzer;
a gas analyzer configured to analyze the separated gas from the separation vessel; and
a liquid analyzer configured to analyze the separated liquid from the separation vessel.

6. The geothermal power generation system according to claim 5, wherein
the controller is configured to determine at least one detergent from the plurality of detergent candidates, based on a gas analysis result of the analyzer, and to control supply of the detergent.

7. The geothermal power generation system according to claim 6, wherein
the gas analyzer is configured to measure a concentration of oxygen and a concentration of carbon dioxide.

8. The geothermal power generation system according to claim 7, wherein
the liquid analyzer is configured to measure a pH level, a dielectric constant, and a dissolved ion concentration.

9. The geothermal power generation system according to claim 8, wherein
the separation vessel is configured to separate the solid substances, the liquid, and the gas contained in the geothermal brine by generating a swirling flow inside the separation vessel.

10. The geothermal power generation system according to claim 9, wherein
the separation vessel includes
a housing having a cylindrical shape and arranged such that an axis of the housing is at an angle within a range of 0° or more and less than 90° with respect to a vertical direction;
a geothermal brine inlet provided on a side surface of the housing and through which the geothermal brine flows in; and
a geothermal brine outlet through which the geothermal brine is discharged; and
a first chamber, a second chamber, and a third chamber arranged adjacently from an upper side in the vertical direction, wherein
the first chamber, the second chamber, and the third chamber communicate with each other at a central portion thereof,
the first chamber includes on an upper surface thereof a gas outlet for discharging separated gas,
the second chamber includes on a side surface thereof a first solid-substance outlet for discharging separated solid substances,
the third chamber includes on a lower surface thereof a second solid-substance outlet for discharging the separated solid substances, and includes on a side surface thereof a liquid outlet for discharging separated liquid, and
the geothermal brine inlet and the geothermal brine outlet are provided on the side surface of the second chamber, and the geothermal brine inlet is arranged on a lower side relative to the geothermal brine outlet in a vertical direction.

11. The geothermal power generation system according to claim 10, further comprising:
a recovery tank connected to the first solid-substance outlet and the second solid-substance outlet and accommodating the solid substances discharged from the first solid-substance outlet and the second solid-substance outlet.

12. The geothermal power generation system according to claim 11, wherein
the detergent addition device includes
a plurality of chemical agent tanks each configured to accommodate one of the plurality of detergent candidates;
a chemical agent injection pump configured to introduce the detergent into the third pipe;
a water tank arranged on the upstream side relative to the plurality of chemical agent tanks and configured to store water; and
a liquid feed pump configured to introduce the water into the third pipe.

13. The geothermal power generation system according to claim 12, wherein
the plurality of detergent candidates include two or more kinds selected from a group including an acidic agent, a basic agent, a chelating agent, a hydrogen peroxide agent, a dispersant, and a catalase agent.

14. The geothermal power generation system according to claim 13, further comprising:
a fourth valve provided in a flow path connecting the first solid-substance outlet and the second solid-substance outlet to the recovery tank, wherein
the controller causes the analysis line and the analyzer to take in the geothermal brine with the fourth valve closed, before determining the detergent, and to collect the separated solid substances in the separation vessel, closes the first valve, the second valve, and the third valve, and causes the detergent addition device to supply the acidic agent or the hydrogen peroxide agent to the analysis line, and
the analyzer analyzes the gas generated by a chemical reaction between the solid substances and the acidic agent or the hydrogen peroxide agent.

15. The geothermal power generation system according to claim 14, wherein
the controller is configured to determine a cleaning state based on the analysis result of the components contained in a fluid analyzed by the analyzer, after distributing the fluid, which is obtained by adding the detergent to the geothermal brine flowing through the third pipe by the detergent addition device, through the detergent supply line, the first pipe, the second pipe, and the third pipe.

16. The geothermal power generation system according to claim 15, wherein
the water stored in the water tank is one kind selected from a group including tap water, river water, and distilled water.
